(19) United States
(12) Patent Application Publication
(10) Pub. No.: US 2017/0131660 A1
(43) Pub. Date: May 11, 2017

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Masao Ando, Numazu (JP)

(21) Appl. No.: 14/936,750

(22) Filed: Nov. 10, 2015

(51) Int. Cl. G03G 15/16

(52) U.S. Cl. CPC G03G 15/1615; G03G 15/1665

(57) ABSTRACT

A transfer roller is arranged at the inside of a first intermediate transfer belt. The transfer roller faces the first transfer position. A transfer bias voltage having a charged polarity opposite to that of the first toner is applied to the transfer roller. The transfer roller transfers a first toner image to a first surface of a sheet. The transfer roller further transfers a second toner image to a second surface at the opposite side to the first surface on the sheet. A fixing device heats and fixes the first toner image and the second toner image that are transferred to the sheet on a sheet simultaneously.

### FIELD

Embodiments described herein relate generally to an image forming apparatus and an image forming method.

### BACKGROUND

There is an image forming apparatus which fixes toner on a sheet. In some cases, the image forming apparatus carries out an image formation on both sides of a sheet (referred to as a duplex printing). In this case, the image forming apparatus forms a first toner image that is to be transferred to the front side of the sheet. After transferring the first toner image to the front side of the sheet, the image forming apparatus fixes the first toner image on the front side of the sheet through a fixing device. The sheet is reversed by a reversing device after the fixing processing is ended. Then, the image forming apparatus forms a second toner image that is to be transferred to the back side of the sheet. The image forming apparatus receives the sheet supplied from the reversing device. After transferring the second toner image to the back side of the sheet, the image forming apparatus fixes the second toner image on the back side of the sheet through the fixing device.

The fixing device is provided with a heat roller and a press roller. The heat roller and the press roller nip the sheet therebetween to heat and press the toner images.

In the duplex printing, the image forming apparatus carries out image formation operation and fixing operation twice on one single sheet. Thus, compared to the simplex printing, it takes more than twice the time. Further, in a case in which the fixing device fixes a toner image on single side, it is also required to preheat the press roller through the heat roller. The energy consumption in the fixing device is about two times the simplex printing.

There is a problem that the printing time and the power consumption in the duplex printing are increased when compared with those in the simplex printing.

### BRIEF DESCRIPTION OF THE DRAWINGS

FIG. 1 is a schematic cross-sectional view illustrating an example of the whole constitution of an image forming apparatus according to a first embodiment;

FIG. 2 is a schematic cross-sectional view of the vicinity of a transfer position of the image forming apparatus according to the first embodiment;

FIG. 3 is a schematic cross-sectional view illustrating an example of the constitution of a fixing device of the image forming apparatus according to the first embodiment;

FIG. 4 is a block diagram illustrating an example of the functional components of the image forming apparatus according to the first embodiment;

FIG. 5 is a schematic cross-sectional view illustrating an example of the whole constitution of an image forming apparatus according to a second embodiment;

FIG. 6 is a schematic cross-sectional view illustrating an example of the whole constitution of an image forming apparatus according to a third embodiment;

FIG. 7 is a block diagram illustrating an example of the functional components of the image forming apparatus according to the third embodiment;

FIG. 8 is a schematic cross-sectional view illustrating an example of the whole constitution of an image forming apparatus according to a fourth embodiment; and

FIG. 9 is a block diagram illustrating an example of the functional components of the image forming apparatus according to the fourth embodiment.

### DETAILED DESCRIPTION

In accordance with an embodiment, an image forming apparatus comprises a first image forming section, a first intermediate transfer belt, a second image forming section, an image carrier, a conveyance section, a transfer roller, and a fixing device. The first image forming section forms a first toner image using the first toner. The first intermediate transfer belt is formed by an endless belt. The first toner image is primarily transferred from the first image forming section to the first intermediate transfer belt. The first intermediate transfer belt moves the first toner image that is primarily transferred to a first secondary transfer position. The second image forming section forms a second toner image using the second toner that is charged with opposite polarity to that of the first toner. The image carrier abuts against the first intermediate transfer belt at the first transfer position. The image carrier further carries the second toner image. The image carrier further moves the second toner image to a second transfer position. The second transfer position faces the first transfer position. The conveyance section conveys a sheet between the first transfer position and the second transfer position. The transfer roller is arranged at the inside of the first intermediate transfer belt. The transfer roller faces the first transfer position. A transfer bias voltage having a charged polarity opposite to that of the first toner is applied to the transfer roller. The transfer roller transfers the first toner image to a first surface of the sheet. The transfer roller further transfers the second toner image to a second surface at the opposite side to the first surface on the sheet. The fixing device heats and fixes the first toner image and the second toner image that are transferred to the sheet on the sheet simultaneously.

Hereinafter, the image forming apparatus and the image forming method according to the embodiment are described with reference to the accompanying drawings. In addition, unless otherwise specified, same components are applied with the same reference numerals in the drawings.

### A First Embodiment

An image forming apparatus and an image forming method according to the first embodiment are described.

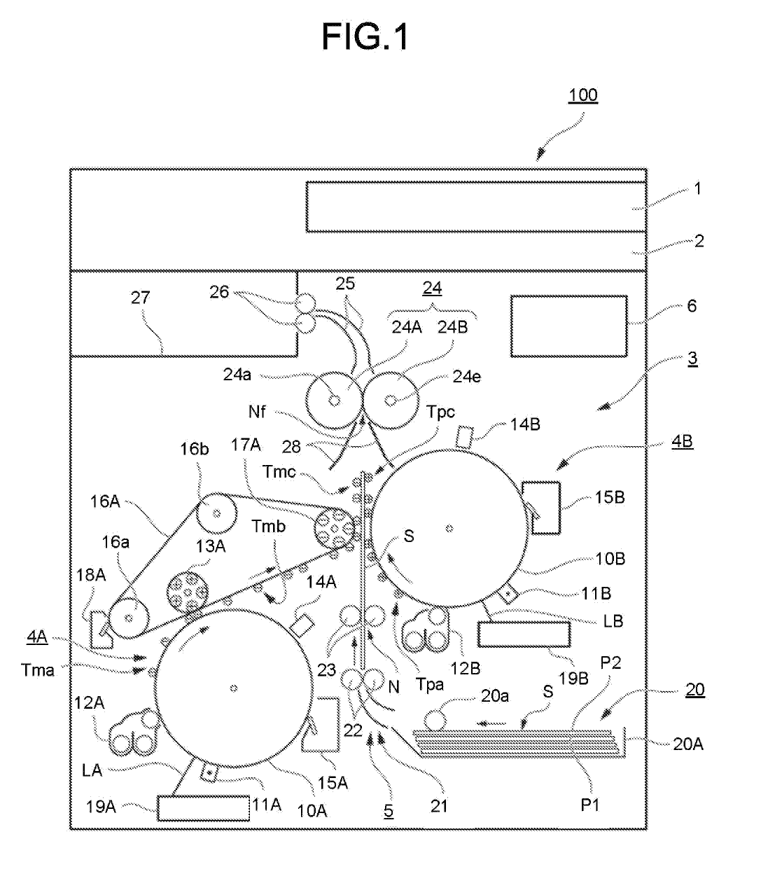

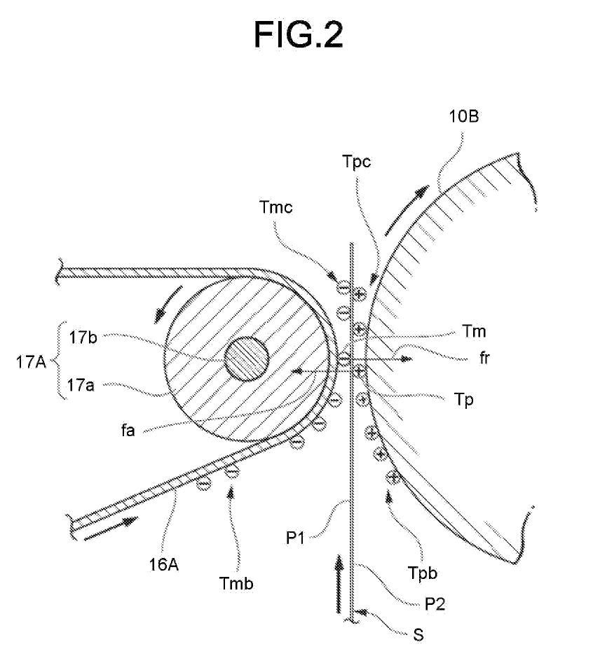

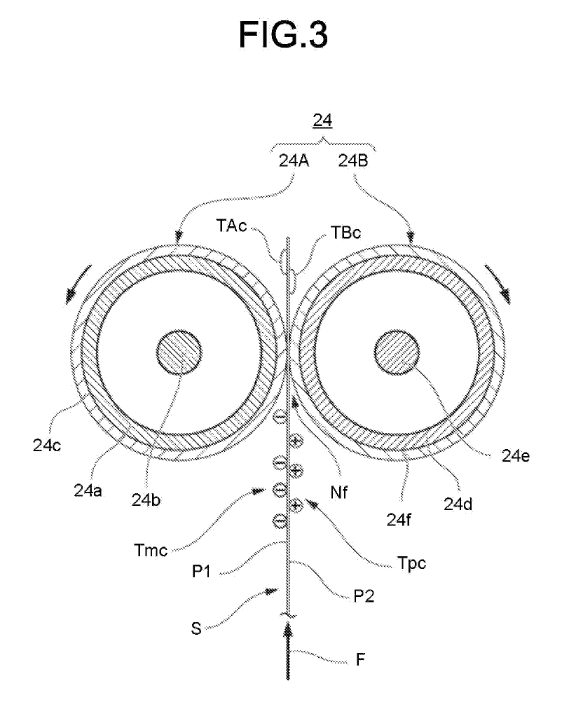

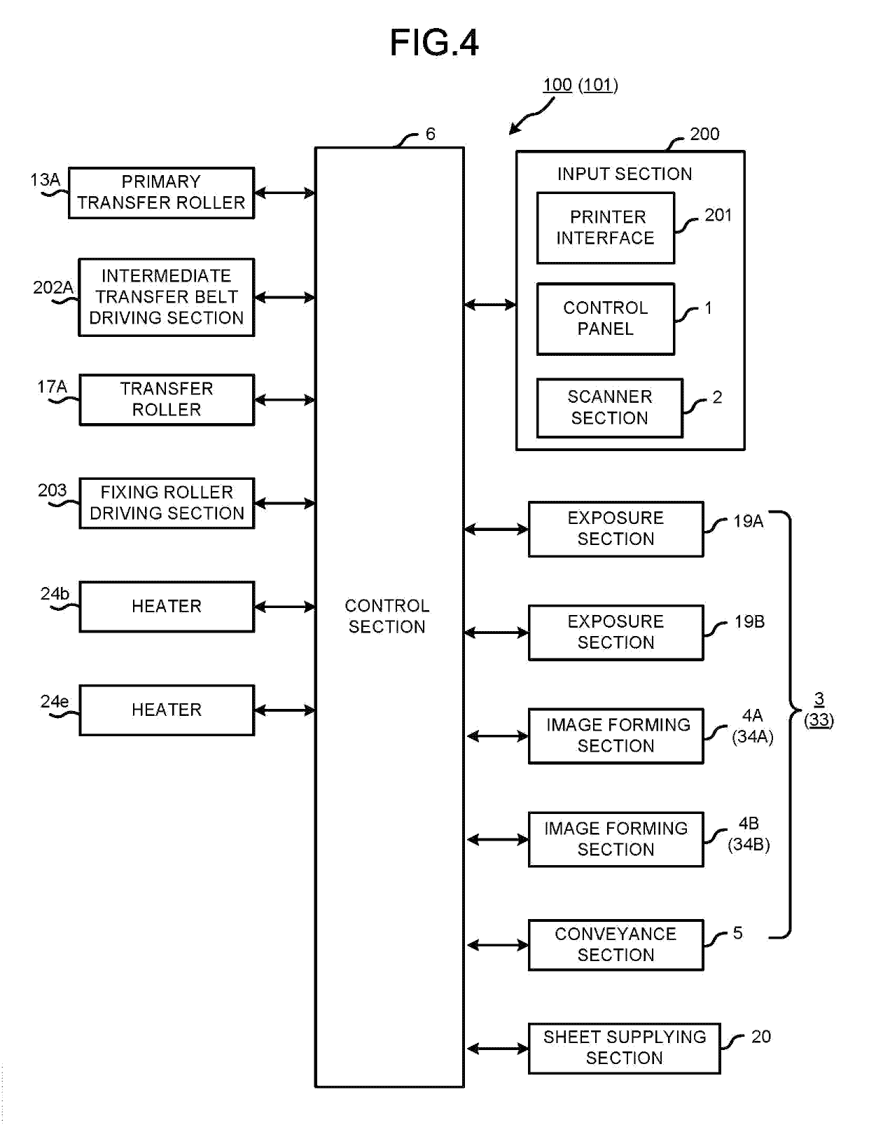

FIG. 1 is a schematic cross-sectional view illustrating an example of the whole constitution of an image forming apparatus according to the first embodiment. FIG. 2 is a schematic cross-sectional view of the vicinity of a transfer position of the image forming apparatus according to the first embodiment. FIG. 3 is a schematic cross-sectional view illustrating an example of the constitution of a fixing device of the image forming apparatus according to the first embodiment. FIG. 4 is a block diagram illustrating an example of the functional components of the image forming apparatus according to the first embodiment.

As shown in FIG. 1, an image forming apparatus 100 of the first embodiment is provided with a control panel 1, a scanner section 2, a printer section 3, a sheet supplying section 20 and a control section 6.

The control panel 1 enables the image forming apparatus 100 to operate through the operation of an operator on the control panel 1.

The scanner section 2 reads image information of a copy object as light brightness and darkness. The scanner section 2 outputs the read image information to the printer section 3.

The printer section 3 forms an output image (hereinafter referred to as a toner image) through a developing agent including toner and the like based on the image information read by the scanner section 2 or an image signal from an external device.

The printer section 3 transfers the toner image to the surface of a sheet S. The printer section 3 applies heat and pressure to the toner image on the surface of the sheet S to fix the toner image on the sheet S.

The printer section 3 carries out a simplex printing or a duplex printing on the sheet S. In the simplex printing, an image is formed on either a first surface P1 or a second surface P2 of the surfaces of the sheet S. In the duplex printing, an image is formed on both the first surface P1 and the second surface P2 of the surfaces of the sheet S simultaneously.

The sheet supplying section 20 supplies the sheet S one by one to the printer section 3 at a timing at which the printer section 3 forms a toner image. The sheet supplying section 20 is provided with a sheet feed cassette 20A. The sheet feed cassette 20A houses the sheet S. The sheet S is stacked in the sheet feed cassette 20A in such a manner that the first surface P1 is set to a lower surface.

The sheet feed cassette 20A is provided with a sheet feed roller 20a. The sheet feed roller 20a picks up the sheet S one by one from the sheet feed cassette 20A.

The picked up sheet S is moved to the conveyance section 5 inside the printer section 3. As FIG. 1 is a schematic view, the drawing of the sheet feed roller 20a has been simplified. For example, the sheet feed roller 20a may include a plurality of rollers such as a pickup roller, a separation roller and the like.

In addition to the sheet feed cassette 20A, the sheet supplying section 20 may be provided with other sheet feed cassette which feeds a sheet S of other category and other size. Similar to the sheet feed cassette 20A, the other sheet feed cassette is also provided with the sheet feed roller 20a.

The sheet supplying section 20 may further include a manual feeding tray and a manual sheet feeding mechanism.

The conveyance section 5 is provided with a conveyance guide 21, a conveyance roller 22 and a register roller 23. The conveyance guide 21 changes the conveyance route of the sheet S supplied from the sheet supplying section 20 to the upward vertical direction. The conveyance roller 22 is positioned above the conveyance guide 21. The conveyance roller 22 conveys the sheet S that is directed to the upward vertical direction from the conveyance guide 21 along the vertical plane.

The register roller 23 is positioned vertically above the conveyance roller 22. The register roller 23 aligns the position of the front end of the sheet S. The register roller 23 conveys the sheet S of which the position is aligned. The conveyance timing of the register roller 23 is determined according to a timing at which the printer section 3 secondarily transfers the toner image to the sheet S.

The conveyance roller 22 abuts the front end in the conveyance direction of the sheet S against a nip N of the register roller 23. The conveyance roller 22 bends the sheet S to align the position of the front end of the sheet S in the conveyance direction.

The register roller 23 aligns the front end of the sheet S in the nip N. Further, the register roller 23 conveys the sheet S upward vertically. A later-described fixing device 24 is positioned above the register roller 23.

Next, the detailed constitution of the printer section 3 is described.

The printer section 3 comprises an image forming section 4A (first image forming section), an intermediate transfer belt 16A (first intermediate transfer belt) and a transfer belt cleaning unit 18A. The printer section 3 is further provided with an image forming section 4B (second image forming section) and the fixing device 24.

The image forming section 4A forms a toner image Tma (first toner image) using a toner tm (first toner). The toner tm is charged to negative polarity. No limitation is given to the color of the toner tm. In the first embodiment, it is exemplified that the color of the toner tm is black.

The image forming section 4A is provided with a photoconductive drum 10A. The photoconductive drum 10A has a photoconductive layer on the surface of a metal drum. The potential of the metal drum is the same potential as the reference potential of the image forming apparatus 100. Hereinafter, unless otherwise specified, when describing the negative and positive potentials, it refers to the negative and positive reference potentials of the image forming apparatus 100.

The surface of the photoconductive drum 10A is charged to negative polarity through a later-described charger 11A. When light is irradiated to the photoconductive layer, the charged charge of the exposed portion is removed.

The charger 11A, an exposure section 19A, a developing device 12A, a primary transfer roller 13A, a charge removing device 14A and a cleaning unit 15A are arranged around the photoconductive drum 10A in the image forming section 4A. The charger 11A, the developing device 12A, the primary transfer roller 13A, the charge removing device 14A and the cleaning unit 15A are arranged in the order in the clockwise direction shown in FIG. 1.

The primary transfer roller 13A is opposite to the photoconductive drum 10A across a later-described intermediate transfer belt 16A. A position on the outer peripheral surface of the intermediate transfer belt 16A nipped by the primary transfer roller 13A and the photoconductive drum 10A is a first primary transfer position.

The charger 11A charges the surface of the photoconductive drum 10A to negative polarity. For example, the charger 11A can adopt a corona discharge charger, a needle electrode charger, a charging roller and the like.

The exposure section 19A irradiates the surface of the photoconductive drum 10A with exposure light LA. The exposure light LA is modulated based on an image signal sent from the scanner section 2 or an external device. The image signal sent from the scanner section 2 or the external device to the exposure section 19A corresponds to an image to be formed on the first surface Pb of the sheet S.

The exposure section 19A forms an electrostatic latent image on the photoconductive drum 10A according to the image signal. The irradiated position of the exposure light LA is located between the arranged position of the charger 11A and the arranged position of the later-described developing device 12A. As long as the exposure light LA can irradiate the aforementioned irradiated position, no specific limitation is given to the arranged position of the exposure section 19A.

For example, the exposure section 19A may have a constitution that can scan laser beams. For example, the exposure section 19A may also have a constitution that carries out solid scanning using LED light-emitting elements.

The developing device 12A charges the toner tm to negative polarity. If a developing bias voltage is applied, the developing device 12A develops the electrostatic latent image on the photoconductive drum 10A through the toner tm. The toner tm adhered to the photoconductive drum 10A forms the toner image Tma according to the electrostatic latent image.

As to the developing device 12A, a well-known two-component developing device or a one-component developing device may be adopted.

The primary transfer roller 13A primarily transfers the toner image Tma adhered to the photoconductive drum 10A to the later-described intermediate transfer belt 16A. In response to a primary transfer timing, a positive transfer voltage is applied to the primary transfer roller 13A. When the positive transfer voltage is applied to the primary transfer roller 13A, the toner image Tma is primarily transferred from the photoconductive drum 10A to the intermediate transfer belt 16A.

The charge removing device 14A irradiates the surface of the photoconductive drum 10A with light to remove the charge on the surface of the photoconductive drum 10A.

The cleaning unit 15A removes the residual toner on the surface of the photoconductive drum 10A. The cleaning unit 15A collects the removed residual toner.

The intermediate transfer belt 16A is an endless belt. The intermediate transfer belt 16A is arranged above the photoconductive drum 10A. The intermediate transfer belt 16A is rotated in an opposite direction to the rotation direction of the photoconductive drum 10A in synchronization with the rotation of the photoconductive drum 10A.

The intermediate transfer belt 16A is formed of a rubber material having an insulating property.

The primary transfer roller 13A abuts against the inner peripheral surface of the intermediate transfer belt 16A. The intermediate transfer belt 16A is pressed against the surface of the photoconductive drum 10A by the primary transfer roller 13A at least at the time of the primary transfer process.

Further, a driving roller 16a and a transfer roller 17A abut against the inner peripheral surface of the intermediate transfer belt 16A such that the primary transfer roller 13A is arranged between the driving roller 16a and the transfer roller 17A.

The driving roller 16a is arranged at the upstream side in the rotation direction of the intermediate transfer belt 16A with respect to the primary transfer roller 13A. The driving roller 16a drives to rotate the intermediate transfer belt 16A.

The transfer roller 17A is arranged at the downstream side in the rotation direction of the intermediate transfer belt 16A with respect to the primary transfer roller 13A.

As shown in FIG. 2, the transfer roller 17A is arranged at the side of the first surface P1 of the sheet S conveyed by the register roller 23. The transfer roller 17A faces the first surface P1 of the sheet S across the intermediate transfer belt 16A.

The transfer roller 17A is provided with a rotation axis 17b and a metal roller 17a.

The rotation axis 17b is connected to an intermediate transfer belt driving section 202A which is described later. The rotation axis 17b is rotated in the anticlockwise direction shown in FIG. 2 through the intermediate transfer belt driving section 202A.

A negative transfer voltage is applied to the metal roller 17a. When the negative transfer voltage is applied to the metal roller 17a, a toner image Tmb is secondarily transferred to the sheet S. The transfer voltage applied to the metal roller 17a is controlled by a later-described control section 6.

The position at the intermediate transfer belt 16A where the intermediate transfer belt 16A abuts against the first surface P1 of the sheet S is a first transfer position where the toner image Tmb is to be secondarily transferred to the sheet S. The toner image Tmb that has been secondarily transferred to the sheet S is hereinafter referred to as a toner image Tmc.

The driving roller 16a and the transfer roller 17A are driven by the intermediate transfer belt driving section 202A (refer to FIG. 4).

The intermediate transfer belt driving section 202A is provided with a driving motor and a driving transmission section (neither is shown). The intermediate transfer belt driving section 202A matches the rotation directions with each linear velocity of the driving roller 16a and the transfer roller 17A.

As shown in FIG. 1, the driving roller 16a and the transfer roller 17A stretch the intermediate transfer belt 16. A tension roller 16b abuts against the inner peripheral surface of the intermediate transfer belt 16A between the driving roller 16a and the transfer roller 17A. The inner peripheral surface where the tension roller 16b abuts against the intermediate transfer belt 16A is an opposite side (upper side shown in FIG. 1) to the side of the inner peripheral surface where the primary transfer roller 13A abuts against the intermediate transfer belt 16A.

The tension roller 16b presses the inner peripheral surface of the intermediate transfer belt 16A towards outside. The tension roller 16b maintains the tension force of the intermediate transfer belt 16A at a constant value.

The transfer belt cleaning unit 18A is arranged at the outer periphery of the intermediate transfer belt 16A. The transfer belt cleaning unit 18A faces the driving roller 16a across the intermediate transfer belt 16A.

The transfer belt cleaning unit 18A removes the residual toner on the outer peripheral surface of the intermediate transfer belt 16A. The transfer belt cleaning unit 18A collects the removed residual toner.

The image forming section 4B forms a toner image Tpa (second toner image) using a toner tp (second toner). The toner tp is charged to positive polarity. No limitation is given to the color of the toner tp. In the first embodiment, the color of the toner tp is the same as that of the toner tm.

The image forming section 4B is provided with a photoconductive drum 10B (image carrier). The photoconductive drum 10B has a photoconductive layer on the surface of a metal drum. The potential of the metal drum is the same potential as the reference potential of the image forming apparatus 100.

The surface of the photoconductive drum 10B is charged to positive polarity through a later-described charger 11B. When light is irradiated to the photoconductive layer, the charged charge of the exposed portion is removed.

The charger 11B, an exposure section 19B, a developing device 12B, a charge removing device 14B and a cleaning unit 15B are arranged around the photoconductive drum 10B in the image forming section 4B. The charger 11B, the developing device 12B, the charge removing device 14B and the cleaning unit 15B are arranged in the order in the anticlockwise direction shown in FIG. 1.

The photoconductive drum 10B faces the transfer roller 17A across the intermediate transfer belt 16A. A part between the developing device 12B and the charge removing device 14B in the clockwise direction shown in FIG. 1 on the surface of the photoconductive drum 10B abuts against the intermediate transfer belt 16A.

The later-described control section 6 enables the intermediate transfer belt 16A and the photoconductive drum 10B to rotate at same linear velocity.

The charger 11B charges the surface of the photoconductive drum 10B to positive polarity. For example, the charger 11B can adopt a corona discharge charger, a needle electrode charger, a charging roller and the like.

The exposure section 19B irradiates the surface of the photoconductive drum 10B with exposure light LB. The exposure light LB is modulated based on an image signal sent from the scanner section 2 or an external device. The image signal sent from the scanner section 2 or the external device to the exposure section 19B corresponds to an image to be formed on the second surface P2 of the sheet S.

The exposure section 19B forms an electrostatic latent image on the photoconductive drum 10B according to the image signal. The irradiated position of the exposure light LB is located between the arranged position of the charger 11B and the arranged position of the later-described developing device 12B. As long as the exposure light LB can irradiate the aforementioned irradiated position, no specific limitation is given to the arranged position of the exposure section 19B.

In addition to the arrangement of components, the exposure section 19B can adopt same constitution as that of the exposure section 19A.

The developing device 12B charges the toner tp to positive polarity. If a developing bias voltage is applied, the developing device 12B develops the electrostatic latent image on the photoconductive drum 10B through the toner tp. The toner tp adhered to the photoconductive drum 10B forms the toner image Tpa according to the electrostatic latent image.

As to the developing device 12B, a well-known two-component developing device or a one-component developing device may be adopted.

The charge removing device 14B irradiates the surface of the photoconductive drum 10B with light to remove the charge on the surface of the photoconductive drum 10B.

The cleaning unit 15B removes the residual toner on the surface of the photoconductive drum 10B. The cleaning unit 15B collects the removed residual toner.

The image forming section 4B has no module of transferring the toner image Tpa formed on the surface of the photoconductive drum 10B to the sheet S.

However, the toner image Tpa is transferred to the second surface P2 of the sheet S by applying a transfer bias voltage to the transfer roller 17A.

The position at the photoconductive drum 10B where the photoconductive drum 10B abuts against the second surface P2 of the sheet S is a second transfer position where the toner image Tpa is to be transferred to the sheet S. The toner image Tpa that has been transferred to the sheet S is hereinafter referred to as a toner image Tpc.

In the image forming apparatus 100, the first transfer position and the second transfer position are opposite to each other.

In a case of carrying out duplex printing, the image forming apparatus 100 simultaneously transfers the toner image Tmb and the toner image Tpa to the sheet S at the first transfer position and the second transfer position respectively.

The length of route from the exposure position of the exposure light LA to the first transfer position may be different from the length of route from the exposure position of the exposure light LA to the second transfer position.

In a case in which there is a difference in the length of route, the later-described control section 6 controls the exposure start timing of the exposure light LA and the exposure start timing of the exposure light LB.

The fixing device 24 is provided with a fixing roller 24A (first roller) and a fixing roller 24B (second roller). A warming cover (not shown) may be arranged around the fixing device 24 as long as it will not hinder the conveyance of the sheet S.

The fixing roller 24A and the fixing roller 24B are arranged in parallel to each other. The fixing roller 24A and the fixing roller 24B contact with each other. A nip Nf is formed in the contacted part of the fixing roller 24A and the fixing roller 24B. The nip Nf extends in the longitudinal direction of the fixing roller 24A and the fixing roller 24B.

The fixing device 24 is positioned above the transfer roller 17A and the photoconductive drum 10B. The nip Nf is positioned on the same plane as a vertical plane on which a contacted part of the transfer roller 17A and the photoconductive drum 10B is contained. The nip Nf is parallel with the contacted part of the transfer roller 17A and the photoconductive drum 10B. Hereinafter, the vertical plane on which the contacted part of the transfer roller 17A and the photoconductive drum 10B and the nip Nf are contained is referred to as a conveyance plane between transfer process and fixing process.

The fixing rollers 24A and 24B have same constitution with each other.

As shown in FIG. 3, the fixing roller 24A (24B) is provided with a metal roller 24a (24d), a surface coated section 24c (24f) and a heater 24b (24e) serving as a first (second) heater.

The metal roller 24a (24d) is formed into a hollow circular pipe shape. The metal roller 24a (24d) is rotated anticlockwise (clockwise) as shown in FIG. 3 through a fixing roller driving section 203 (refer to FIG. 4).

The fixing roller driving section 203 includes a driving motor and a transmission mechanism (neither is shown). The fixing roller driving section 203 synchronizes each rotational speed of the metal rollers 24a and 24d. The fixing roller driving section 203 matches each of the linear velocity of the fixing rollers 24A and 24B with the conveyance speed of the sheet S.

Pressurizing springs (neither is shown) are arranged at both ends in the longitudinal direction of the metal roller 24a (24d). The pressurizing springs press the metal rollers 24a and 24d in opposite direction to each other.

The surface coated section 24c (24f) is a soft elastic body which coats the outer surface of the metal roller 24a (24b). As the material of the surface coated section 24c (24f), a rubber material that is resistant to a fixing temperature at which the toner tm and the toner tp are fixed on the sheet S can be adopted. A resin coated may be arranged on the surface of the surface coated section 24c (24f). The resin coated may include resin material excellent in mold-releasability of each of the toner tm and the toner tp.

The surface coated section 24c (24f) forms a uppermost surface of the fixing roller 24A (24B). A part where the surface coated sections 24c and 24f are contacted with each other forms the nip Nf.

The nip Nf is an area where the toner image Tmb is fixed on the first surface 21 of the sheet S. The nip Nf is further an area where the toner image Tpb is fixed on the second surface 22 of the sheet S.

It is assumed that the width of the nip Nf in the conveyance direction F of the sheet S is such a width that the heat and press when fixing the toner image Tmb and the toner image Tpb simultaneously can be carried out.

The heater 24b (24e) heats the metal roller 24a (24d). The calorific value of the heater 24b (24e) is controlled by the later-described control section 6. The control section 6 at least controls the temperature of the nip Nf to a temperature required in the fixing of the toner images Tmb and Tpb at the time of the fixing operation.

For example, a halogen heater lamp, an induction heating (IH) heater and the like can be listed as the constitution example of the heater 24b (24e).

The fixing device 24 with such a constitution fixes the toner image Tmb that is secondarily transferred to the first surface P1 of the sheet S on the first surface P1 of the sheet S. Further, the fixing device 24 fixes the toner image Tpb that is secondarily transferred to the second surface P2 of the sheet S on the second surface P2 of the sheet S.

In a case in which the duplex printing is carried out, the fixing device 24 fixes the toner images Tmb and Tpb simultaneously on the sheet S.

As shown in FIG. 1, an entry guide 28 is arranged below the nip Nf of the fixing device 24.

In a case in which the sheet S deviates from the conveyance surface between transfer process and fixing process, the entry guide 28 guides the front end of the sheet S towards the conveyance surface between transfer process and fixing process.

The entry guide 28 includes two plate-like members. The two plate-like members are opposite to each other across the conveyance surface between transfer process and fixing process. The facing intervals between the two plate-like members are gradually reduced in a direction from bottom to top.

The printer section 3 is further provided with a sheet discharge guide 25, a sheet discharge roller 26 and a sheet discharge tray 27.

The sheet discharge guide 25 changes the conveyance direction of the sheet S subjected to fixing processing.

The sheet S subjected to fixing processing is moved towards the sheet discharge guide 25 upward vertically through the intermediate transfer belt 16A and the photoconductive drum 10B. The sheet S subjected to fixing processing is guided from the fixing device 24 to the sheet discharge roller 26 by the sheet discharge guide 25. The sheet discharge guide 25 changes the conveyance direction of the sheet S subjected to fixing processing to the horizontal direction.

The sheet discharge roller 26 discharges the sheet S passing through the sheet discharge guide 25 to the sheet discharge tray 27.

The sheet discharge tray 27 stacks the sheet S discharged from the sheet discharge roller 26. In the embodiment, the sheet S is horizontally placed in the sheet discharge tray 27 above the image forming section 4A.

As shown in FIG. 4, the control section 6 is connected to be capable of communicating with all devices of the image forming apparatus 100. The control section 6 controls each device of the image forming apparatus 100.

The control carried out by the control section 6 contains the control of the scanner section 2, the control of the printer section 3, and the control of sheet feeding, conveyance, sheet discharge of the sheet S.

The control section 6 is connected to be capable of communicating with the input section 200, the printer section 3, the conveyance section 5 and the sheet supplying section 20. The control section 6 carries out the control of image forming operation based on the command input through the input section 200.

The input section 200 is provided with a printer interface 201, the control panel 1 and the scanner section 2 that are described above.

The printer interface 201 is an interface when the image forming apparatus 100 is used as a printer. The printer interface 201 is connected with the communication line. The printer interface 201 sends information of operation command of the image forming apparatus 100 and the image signal that should be printed to the control section 6 via the communication line.

The control section 6 controls the operations of the exposure section 19A and the image forming section 4A based on an image signal that should be printed on the first surface P1 of the sheet S among the image signals input through the input section 200.

The control section 6 simultaneously controls the operations of the exposure section 19B and the image forming section 4B based on an image signal that should be printed on the second surface P2 of the sheet S among the image signals input through the input section 200.

The control section 6 drives the driving roller 16a and the transfer roller 17A that are described above through the intermediate transfer belt driving section 202A.

The control section 6 drives the fixing rollers 24A and 24B that are described above through the fixing roller driving section 203.

The control section 6 controls the transfer voltage and the transfer voltage applied timing of the primary transfer roller 13A. The control section 6 controls the transfer voltage and the transfer voltage applied timing of the transfer roller 17A.

The control section 6 changes the calorific value of each of the heaters 24b and 24e to carry out a temperature control of the nip Nf based on the output of a temperature sensor (not shown) and the like.

The detailed control carried out by the control section 6 is described as well as the operations of the image forming apparatus 100.

The control section 6 includes a proper hardware and a computer having a CPU, a memory, an input/output interface, an external storage device and the like. The control section 6 executes a control program with the computer to realize the control functions described above. Alternatively, the control section 6 activates a proper hardware to realize the control functions described above.

The image forming apparatus 100 having the constitution described above is an apparatus which carries out an image forming method of the first embodiment. Hereinafter, as to the operations of the image forming apparatus 100, the operations relating to the image forming method of the first embodiment are mainly described.

In the image forming apparatus 100, a command to carry out an image forming operation is input from the control panel 1 or the external device to the control section 6.

The control section 6 determines whether to carry out a simplex printing or to carry out a duplex printing based on the command from the input section 200.

Hereinafter, the operations of duplex printing are described first. The operations of simplex printing are described later.

In the duplex printing, the image forming apparatus 100 forms an image on both the first surface P1 and the second surface P2 simultaneously. In the image forming apparatus 100, the front ends of the images respectively formed by the image forming section 4A and the image forming section 4B reach the first transfer position and the second transfer position simultaneously.

When receiving a command to start an image forming operation from the input section 200, the control section feeds and conveys the sheet S through the sheet supplying section 20 and the conveyance section 5. The sheet S reaches the register roller 23. The front end of the sheet S is aligned in the nip N.

After the front end of the sheet S is aligned in the nip N, the control section 6 enables the image forming section 4A and the image forming section 4B to start image forming operation.

The control section 6 controls the image forming section 4A to carry out following operations.

As shown in FIG. 1, the photoconductive drum 10A rotates clockwise shown in FIG. 1. The charger 11A charges the surface of the photoconductive drum 10A to negative polarity. The exposure section 19A irradiates the surface of the photoconductive drum 10A with the exposure light LA that is modulated based on the image signal. The charge of a part of the surface of the photoconductive drum 10A that is exposed by the exposure light LA is removed according to the amount of exposure. The potential of the part of the surface of the photoconductive drum 10A that is exposed by the exposure light LA is changed from the charged potential to a potential after the exposure. Thus, an electrostatic latent image based on the image signal is formed on the surface of the photoconductive drum 10A.

It is assumed that a timing at which the exposure corresponding to a front end of an image forming range is permitted is a timing t0. A position on the photoconductive drum 10A where the exposure light LA reaches at the timing t0 is the front end of the image forming range. In some cases, no image is formed on the front end of the image forming range according to image signals.

The developing device 12A develops the electrostatic latent image through the toner tm. The toner tm adheres to a part of which the potential is changed to the potential after the exposure on the photoconductive drum 10A. The toner image Tma is formed with the toner tm on the surface of the photoconductive drum 10A.

After a given time from the timing t0, the front end of the image forming range on the photoconductive drum 10A reaches the first primary transfer position. It is assumed that this timing is a timing t1 (however, t1>t0).

On the other hand, the driving roller 16a and the transfer roller 17A are driven by the intermediate transfer belt driving section 202A. Thus, the intermediate transfer belt 16A is rotated in an opposite direction to that of the photoconductive drum 10A at a same linear velocity.

When the front end of the image forming range reaches the first primary transfer position (the timing t1), the positive transfer voltage is started to be applied to the primary transfer roller 13A. The toner image Tma on the photoconductive drum 10A is charged to negative polarity. The primary transfer roller 13A primarily transfers the toner image Tma to the intermediate transfer belt 16A. The toner images Tma are sequentially moved on the intermediate transfer belt 16A to form the toner images Tmb in sequence.

The photoconductive drum 10A on which the transfer of the toner image Tma is completed receives the light irradiation from the charge removing device 14A. In this way, the residual charge on the surface of the photoconductive drum 10A is removed.

The cleaning unit 15A removes the non-transferred toner on the surface of the photoconductive drum 10A. The cleaning unit 15A collects the removed non-transferred toner.

The photoconductive drum 10A is used to repeat the image forming operation as stated above.

On the other hand, the toner image Tmb transferred to the intermediate transfer belt 16A moves together with the intermediate transfer belt 16A. The front end of the image forming range on the intermediate transfer belt 16A reaches the first transfer position at a timing t3 (however, t3>t2).

In the meanwhile, the control section 6 controls the image forming section 4B to enable it to carry out the following operations.

The photoconductive drum 10B rotates anticlockwise shown in FIG. 1. The charger 11B charges the surface of the photoconductive drum 10B to positive polarity. The exposure section 19B irradiates the surface of the photoconductive drum 10B with the exposure light LB that is modulated based on the image signal. The charge of a part of the surface of the photoconductive drum 10B that is exposed by the exposure light LB is removed according to the amount of exposure. The potential of the part of the surface of the photoconductive drum 10B that is exposed by the exposure light LB is changed from the charged potential to a potential after the exposure. Thus, an electrostatic latent image based on the image signal is formed on the surface of the photoconductive drum 10B.

It is assumed that a timing at which the exposure corresponding to a front end of an image forming range is permitted is a timing t0′ (however, t0′<t3). A position on the photoconductive drum 10B where the exposure light LB reaches at the timing t0′ is the front end of the image forming range.

The timing t0′ is a timing at which the front end of the image forming range on the photoconductive drum 10B reaches the second transfer position at the timing t3.

The developing device 12B develops the electrostatic latent image through the toner tp. The toner tp adheres to a part of which the potential is changed to the potential after the exposure on the photoconductive drum 10B. The toner image Tpa is formed with the toner tp on the surface of the photoconductive drum 10B.

The front end of the image forming range on the photoconductive drum 10B reaches the second transfer position at the timing t3.

At a timing ts, the control section 6 drives the register roller 23. The timing ts is a timing between the timing t0 or the timing t0′ and the timing t3. The register roller 23 conveys the sheet S that is aligned in the nip N towards the first and second transfer positions.

The timing ts is a conveyance start timing which enables the front end of the sheet S to arrive the nip Nf at a timing t3′=t3−Δ t (however, Δ t>0). The Δ t is used for forming a margin required at the front end portion of the sheet S even if there is a conveyance error of the sheet S. Thus, at the timing t3, the front end of the sheet S is in a state of being nipped slightly between the intermediate transfer belt 16A and the photoconductive drum 10B.

The control section 6 starts to apply the negative transfer bias voltage to the metal roller 24a before the timing t3′. When the transfer bias voltage is applied, an electric field is generated between the metal roller 24a and the photoconductive drum 10B. The direction of the electric field is a direction from the photoconductive drum 10B to the metal roller 24a.

As shown in FIG. 2, the toner image Tmb, the sheet S, and the toner image Tpb are nipped in this order between the intermediate transfer belt 16A and the photoconductive drum 10B after the timing t3.

The toner image Tmb that is charged to negative polarity receives an external force fr directed to the first surface P1 from the electric field between the metal roller 24a and the photoconductive drum 10B. Thus, the toner image Tmb is secondarily transferred to the first surface P1.

The toner image Tpa that is charged to positive polarity receives an external force fa directed to the second surface P2 from the electric field between the metal roller 24a and the photoconductive drum 10B. Thus, the toner image Tpa is transferred to the second surface P2.

Such a secondary transfer is started from an area adjacent to the first and the second transfer positions according to the size of the transfer voltage.

The sheet S moves upward vertically along with the rotation of the transfer roller 17A and the photoconductive drum 10B. At this time, the toner image Tmc to which the toner image Tmb is transferred is formed on the first surface P1 of the sheet S. The toner image Tpc to which the toner image Tpa is transferred is formed on the second surface P2 of the sheet S.

As long as no disturbance occurs, the sheet S moves on the conveyance plane between transfer process and fixing process. As long as no disturbance occurs, the sheet S moves upward vertically without flexing. In a case of emergency, if the sheet S bends due to the disturbance, the sheet S deviates from the conveyance surface between the transfer process and the fixing process under the action of gravity. At this time, first, the front end of the sheet S abuts against the entry guide 28. The entry guide 28 presses the front end of the sheet S back to the conveyance surface between the transfer process and the fixing process gradually. The bending of the sheet S is gradually eliminated.

The sheet S passes through the entry guide 28 to move towards the nip Nf of the fixing device 24.

In the fixing device 24, the calorific value of the heater 24b (24e) is controlled by the control section 6. The heater 24b (24e) heats the metal roller 24a (24d) and the surface coated section 24c (24f). The temperature of the nip Nf becomes a predetermined fixing temperature before the sheet S reaches the nip Nf.

As shown in FIG. 3, when the sheet S reaches the nip Nf, the toner images Tmc and Tpc on the sheet S are nipped by the fixing rollers 24A and 24B. The fixing rollers 24A and 24B presses the toner images Tmc and Tpc and heats the toner images Tmc and Tpc at the fixing temperature. The toner images Tmc and Tpc fuse in the nip Nf. The fused toner images Tmc and Tpc are fixed on the sheet S through the pressurization force in the nip Nf. In this way, a fixed toner image TAc (TBc) is formed on the first surface P1 (the second surface P2) of the sheet S.

At this time, the heater 24b mainly heats the fixing roller 24A and the toner image Tmc. The heater 24e mainly heats the fixing roller 24B and the toner image Tpc.

For example, in a case in which the fixing device includes a heat roller and a press roller, the heat of the heat roller is transmitted to the press roller through a nip. The heat roller heats the press roller which has no heat source. In order to stabilize the fixing temperature of the nip, it is required to raise the temperature of the press roller and the temperature of the heat roller to about the same degree. The heat energy of the heat roller is consumed to raise the temperature of the press roller and to maintain the temperature of the press roller other than to fuse toner. As the heat capacity of the press roller is large, the heat energy consumed to raise temperature and maintain temperature is also increased.

However, in the image forming apparatus 100 provided with no press roller having no heat source, the heaters 24b and 24e don't need to heat the press roller. Thus, the total power consumption of the heaters 24b and 24e can be remarkably reduced as compared with the power consumption of the heater of the fixing device comprising a heat roller and a press roller. Specifically, the total power consumption of the heaters 24b and 24e is reduced to about half of the power consumption of the heater of the fixing device comprising the heat roller and the press roller.

The conveyance direction of the sheet S which passes through the fixing device 24 is changed through the sheet discharge guide 25 shown in FIG. 1. The sheet S reaches the sheet discharge roller 26 positioned at the front end side of the sheet discharge guide 25. The sheet discharge roller 26 discharges the sheet S to the sheet discharge tray 27. In a case of the image forming apparatus 100, the sheet S is discharged in a state in which the first surface P1 faces the bottom surface of the sheet discharge tray 27.

At this time, the fixed toner image TAc and the fixed toner image TBc are respectively formed on the first surface P1 and the second surface P2 of the sheet S according to the image signal.

As stated above, the description of the operations of the duplex printing are ended.

Next, the operations of the simplex printing are described.

In order to carry out the simplex printing by the image forming apparatus 100, the image forming operation of an image forming section that needs no image formation (either the image forming section 4A or the image forming section 4B) may be stopped. That which one of the image forming sections 4A and 4B will carry out the image formation may be set to be capable of being selected by the input section 200. Alternatively, that which one of the image forming sections 4A and 4B will be used may be set to be fixed.

As one example, in a case of simplex printing, only the image forming section 4A in the image forming apparatus 100 is used. The image forming process using the negative charge toner can form a good-quality image more easily. Further, using the negative charge toner can manufacture the toner and the photoconductive drum at a low cost.

Hereinafter, as to the simplex printing of the image forming apparatus 100, the point different from the duplex printing is mainly described.

In the simplex printing, the control section 6 enables the photoconductive drum 10B to rotate but not enable the image forming section 4B to carry out image formation.

The control section 6 reduces the calorific value of the heater 24e when compared with the duplex printing.

In the simplex printing, it is not required to fuse the toner image on the second surface P2. Further, the heater 24e can only heat the surface coated section 24f that is in close contact with the metal roller 24d having excellent thermal conductivity. Thus, when compared with a case of heating the press roller having large heat capacity from the nip, it is faster to raise the temperature of the surface coated section 24f. Thus, even if the calorific value of the heater 24e is decreased in the simplex printing, the temperature of the nip Nf can be maintained at a proper fixing temperature.

As stated above, the image forming apparatus 100 can carry out a duplex printing only by making the sheet S pass through the fixing device 24 once. Thus, the image forming apparatus 100 can carry out the duplex printing for the same time as the simplex printing. In the image forming apparatus 100, the time used to reverse the sheet S after the simplex printing can be omitted. As a result, the printing time of the duplex printing in the image forming apparatus 100 is reduced to be below half of the time in the case of passing through the fixing device twice.

In the image forming apparatus 100, the fixing rollers 24A and 24B of the fixing device 24 are further respectively provided with a heater 24b and a heater 24e. Thus, when compared with a case of comprising the fixing device consisting of the heat roller and the press roller, the power consumption can be reduced in both the duplex printing and the simplex printing. Specifically, when comparing with a case of the duplex printing, the power consumption is about half.

In the image forming apparatus 100, the transfer roller 17A further carries out the transfer of the toner image Tmb and the transfer of the toner image Tpa. Thus, a transfer device for transferring the toner image Tpa is not required. The number of components of the image forming apparatus 100 is reduced.

In accordance with the image forming apparatus 100, since the operations of the image forming section 4B are stopped at the time of the simplex printing, the power consumption can be reduced as compared with the duplex printing.

In accordance with the image forming apparatus 100, as the sheet S to which the toner images Tmc and Tpc are transferred is conveyed along the vertical plane, it is possible to prevent the rubbing of the unfixed toner.

### A Second Embodiment

An image forming apparatus according to the second embodiment is described.

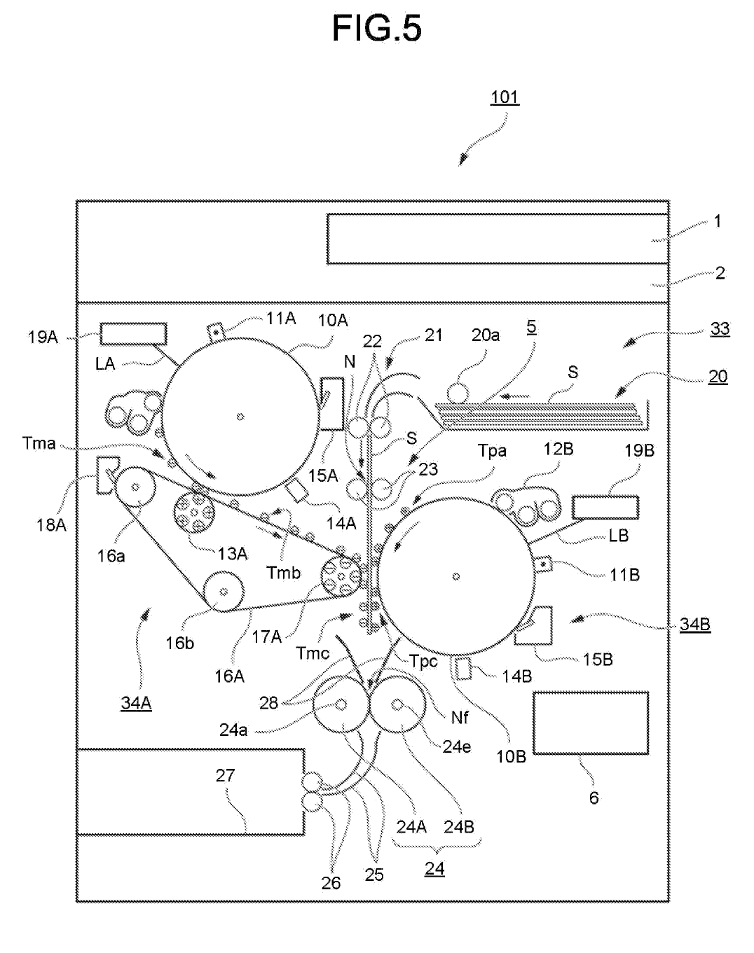

FIG. 5 is a schematic cross-sectional view illustrating an example of the whole constitution of the image forming apparatus according to the second embodiment.

As shown in FIG. 5, an image forming apparatus 101 of the second embodiment is provided with a printer section 33 instead of the printer section 3 of the image forming apparatus 100 of the first embodiment described above.

Hereinafter, the point different from the first embodiment described above is mainly described.

The printer section 33 is provided with an image forming section 34A (first image forming section) and an image forming section 34B (second image forming section) instead of the image forming sections 4A and 4B of the printer section 3.

The image forming sections 34A and 34B are different from the image forming sections 4A and 4B only in the point that the sheet S is conveyed from vertically upward to downward to carry out image formation. In the image forming sections 34A and 34B, all section parts of the image forming sections 4A and 4B are arranged upside down. Thus, the control section 6 rotates the intermediate transfer belt 16A clockwise shown in FIG. 1. The arrangement of each device part around the intermediate transfer belt 16A is opposite to that in the case of comprising the image forming section 4A. The control section 6 enables the photoconductive drum 10B to rotate anticlockwise as shown in FIG. 5. The arrangement of each device part around the photoconductive drum 10B is opposite to that in the case of comprising the image forming section 4B.

According to the change of the arrangement positions described above, the position relation of the sheet supplying section 20, the conveyance section 5, the entry guide 28, the fixing device 24, and the sheet discharge tray 27 is also reversed upside down.

In accordance with such an image forming apparatus 101, since only the conveyance direction of the sheet S is different, it is also possible to carry out the duplex printing and the simplex printing similar to the image forming apparatus 100 of the first embodiment described above.

However, the image forming apparatus 101 conveys the sheet S to which the toner images Tmc and Tpc are transferred from the upper side to the lower side vertically. The sheet S receives gravity in the conveyance direction on the conveyance plane between the transfer process and the fixing process. Even if the sheet S is under the influence of the disturbance, it becomes difficult to deviate from the conveyance surface. In this way, it is possible to prevent the rubbing of the unfixed toner more exactly.

### A Third Embodiment

An image forming apparatus according to the third embodiment is described.

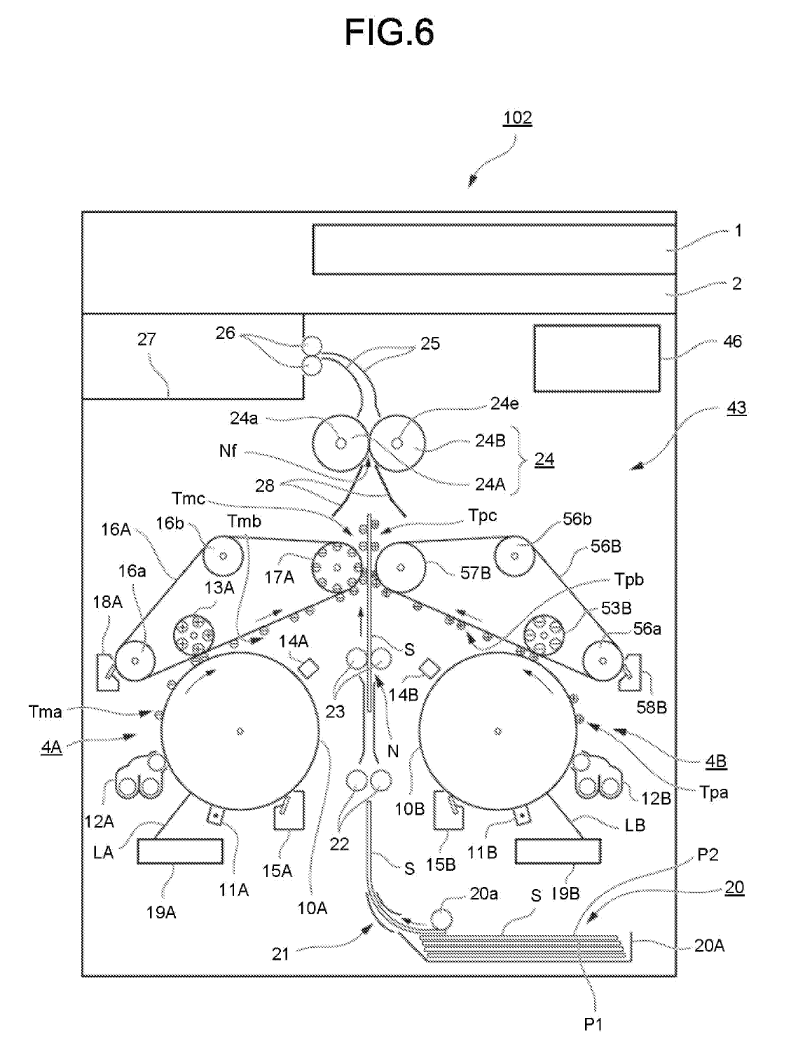

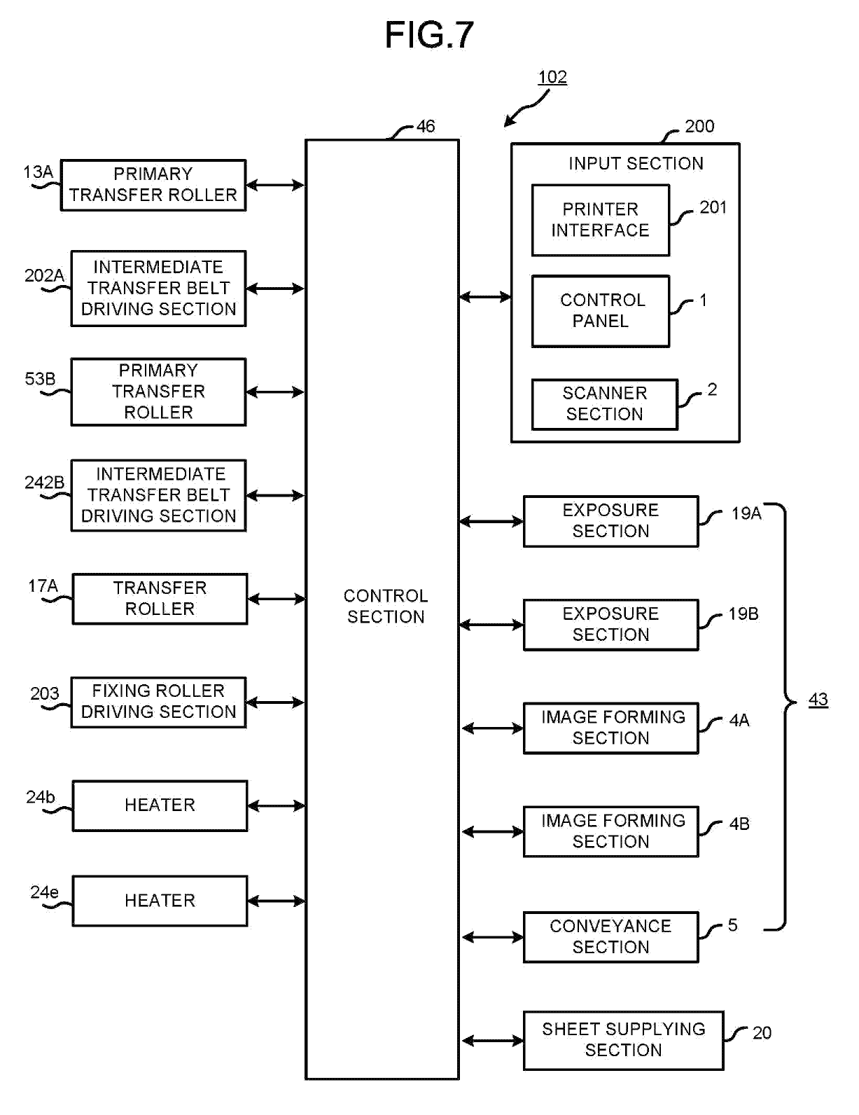

FIG. 6 is a schematic cross-sectional view illustrating an example of the whole constitution of an image forming apparatus according to the third embodiment. FIG. 7 is a block diagram illustrating an example of the functional components of the image forming apparatus according to the third embodiment.

As shown in FIG. 6, an image forming apparatus 102 of the third embodiment is provided with a printer section and a control section 46 instead of the printer section 3 and the control section 6 of the image forming apparatus 100 of the first embodiment described above.

Hereinafter, the point different from the first embodiment described above is mainly described.

In addition to the constitution of the printer section 3, the printer section 43 is also provided with a primary transfer roller 53B, an intermediate transfer belt 56B (second intermediate transfer belt, image carrier), a driving roller 56a, a pressing roller 57B, a tension roller 56b and a transfer belt cleaning unit 58B.

The image forming section 4B of the printer section abuts against the outer peripheral surface of the intermediate transfer belt 56B described later.

The primary transfer roller 53B is opposite to the photoconductive drum 10B across the later-described intermediate transfer belt 56B.

The primary transfer roller 53B primarily transfers the toner image Tpa adhered to the photoconductive drum 10B to the later-described intermediate transfer belt 56B.

In response to a primary transfer timing, a negative transfer voltage is applied to the primary transfer roller 53B. When the negative transfer voltage is applied to the primary transfer roller 53B, the toner image Tpa is primarily transferred from the photoconductive drum 10B to the later-described intermediate transfer belt 56B. Hereinafter, the toner image Tpa that is primarily transferred is referred to as the toner image Tpb.

A position on the outer peripheral surface of the intermediate transfer belt 56B nipped by the primary transfer roller 53B and the photoconductive drum 10B is a second primary transfer position.

The intermediate transfer belt 56B is an endless belt. The intermediate transfer belt 56B is arranged above the photoconductive drum 10B. The intermediate transfer belt 56B is rotated in an opposite direction to the rotation direction of the photoconductive drum 10B in synchronization with the rotation of the photoconductive drum 10B.

The intermediate transfer belt 56B is formed of a rubber material having an insulating property.

The primary transfer roller 53B abuts against the inner peripheral surface of the intermediate transfer belt 56B. The intermediate transfer belt 56B is pressed against the surface of the photoconductive drum 10B by the primary transfer roller 53B at least at the time of the primary transfer process.

Further, the driving roller 56a and the pressing roller 57B abut against the inner peripheral surface of the intermediate transfer belt 56B such that the primary transfer roller 53B is arranged between the driving roller 56a and the pressing roller 57B.

The driving roller 56a is arranged at the upstream side in the rotation direction of the intermediate transfer belt 56B with respect to the primary transfer roller 53B. The driving roller 56a drives to rotate the intermediate transfer belt 56B.

The pressing roller 57B is arranged at the downstream side in the rotation direction of the intermediate transfer belt 56B with respect to the primary transfer roller 53B.

The driving roller 56a and the pressing roller 57B are driven by the intermediate transfer belt driving section 242B (refer to FIG. 7).

The intermediate transfer belt driving section 242B is provided with a driving motor and a driving transmission section (neither is shown). The intermediate transfer belt driving section 242B matches the rotation direction with each rotational linear velocity of the driving roller 56a and the pressing roller 57B.

The pressing roller 57B is arranged at the side of the second surface P2 of the sheet S conveyed by the register roller 23. The pressing roller 57B faces the second surface P2 of the sheet S across the intermediate transfer belt 56B.

The pressing roller 57B also faces the transfer roller 17A across the intermediate transfer belts 56B and 16A. The pressing roller 57B and the transfer roller 17A faces to each other in a horizontal direction orthogonal to the conveyance direction of the sheet S. The pressing roller 57B nips the toner image Tmb, the sheet S, and the toner image Tpb between the pressing roller 57B and the transfer roller 17A to press them to the side of the transfer roller 17A.

As the pressing roller 57B, a metal roller that is adapted to the reference potential of the image forming apparatus 102 can be adopted.

In the image forming apparatus 102, no transfer bias voltage is applied to the pressing roller 57B. However, the toner image Tpb is transferred to the second surface P2 of the sheet S by applying a transfer bias voltage to the transfer roller 17A.

A position on the intermediate transfer belt 56B where the pressing roller 57B abuts against the second surface P2 of the sheet S is a second transfer position at which the toner image Tpb is to be transferred to the sheet S.

In the image forming apparatus 102, the first transfer position and the second transfer position are opposite to each other.

The driving roller 56a and the pressing roller 57B stretch the intermediate transfer belt 56B. A tension roller 56b abuts against the inner peripheral surface of the intermediate transfer belt 56B between the driving roller 56a and the pressing roller 57B. The inner peripheral surface where the tension roller 56b abuts against the intermediate transfer belt 56B is an opposite side (upper side shown in FIG. 6) to the side of the inner peripheral surface where the primary transfer roller 53B abuts against the intermediate transfer belt 56B.

The tension roller 56b presses the inner peripheral surface of the intermediate transfer belt 56B towards outside. The tension roller 56b maintains the tension force of the intermediate transfer belt 56B at a constant value.

The transfer belt cleaning unit 58B is arranged at the outer periphery of the intermediate transfer belt 56B. The transfer belt cleaning unit 58B faces the driving roller 56a across the intermediate transfer belt 56B.

The transfer belt cleaning unit 58B removes the residual toner on the outer peripheral surface of the intermediate transfer belt 56B. The transfer belt cleaning unit 58B collects the removed residual toner.

As shown in FIG. 7, the control section 46 is connected to be capable of communicating with all device parts of the image forming apparatus 102. The control section 46 controls each device part of the image forming apparatus 102. The control section 46 is different from the control section 6 of the first embodiment described above in the controlling of the added intermediate transfer belt driving section 242B and the primary transfer roller 53B.

The control section 46 drives the driving roller 56a and the pressing roller 57B that are described above through the intermediate transfer belt driving section 242B.

The control section 46 further controls the transfer voltage and the transfer voltage applied timing of the first transfer roller 53B in addition to that of the primary transfer roller 13A.

The detailed control carried out by the control section 46 is described as well as the operations of the image forming apparatus 102.

The control section 46 can adopt the same device constitution as that of the control section 6.

As to the operations of the duplex printing of the image forming apparatus 102, the point different from the image forming apparatus 100 of the first embodiment described above is mainly described.

The control section 46 carries out the same control on the image forming section 4A, the primary transfer roller 13A, and the intermediate transfer belt driving section 202A as that carried out by the control section 6 of the first embodiment described above. Thus, the toner image Tmb corresponding to a latent image of which the exposure is started at the timing t0 moves to the first transfer position at the timing t3.

In the meanwhile, the control section 46 carries out the same control on the image forming section 4B as that carried out by the control section 6. The image forming section 4B forms the toner image Tpa on the photoconductive drum 10B. However, if the toner image Tpa moves to the second primary transfer position, the control section 46 applies a negative transfer voltage to the primary transfer roller 53B.

The primary transfer roller 53B primarily transfers the toner image Tpa to the intermediate transfer belt 56B. The toner image Tpa that is primarily transferred forms to be the toner image Tpb on the intermediate transfer belt 56B.

The control section 46 enables the driving roller 56a and the pressing roller 57B to rotate clockwise as shown in FIG. 6 through the intermediate transfer belt driving section 242B. The intermediate transfer belt 56B moves the toner image Tpb to the second transfer position.

The control section 46 controls the exposure timing of the exposure section 19B such that the front end of the image forming range on the intermediate transfer belt 56B is moved to the second transfer position at the timing t3.

The exposure timing of the exposure section 19B is determined according to a difference between a length of route from an exposure position at the photoconductive drum 10A and the intermediate transfer belt 16A to the first transfer position and a length of route from an exposure position at the photoconductive drum 10B and the intermediate transfer belt 56B to the second transfer position.

The conveyance control of the sheet S of the conveyance section 5 and the fixing control of the fixing device 24 in the control section 46 are the same as those in the control section 6.

Thus, the toner images Tmb and Tpb respectively reach the first and the second transfer positions at the timing t3 slightly earlier than the timing when the sheet S reaches the first and the second transfer positions.

Similar to the first embodiment described above, the control section 46 applies a negative transfer bias voltage to the transfer roller 17A. The transfer roller 17A respectively transfers the toner images Tmb and Tpb to the first surface P1 and the second surface P2 of the sheet S simultaneously. The toner images Tmc and Tpc are formed on the sheet S.

Similar to the first embodiment described above, the sheet S reaches the fixing device 24. The fixing device fixes the toner images Tmc and Tpc on the sheet S simultaneously.

In this way, the image forming apparatus 102 carries out the duplex printing.

The image forming apparatus 100 of the first embodiment described above transfers the toner image Tpa from the photoconductive drum 10B to the sheet S. On the other hand, the image forming apparatus 102 primarily transfers the toner image Tpa to the intermediate transfer belt 56B, and then secondarily transfers the toner image Tpa to the sheet S through the transfer roller 17A.

The simplex printing can be carried out as the first embodiment if the image formation of the image forming section 4B is stopped.

For example, it is assumed that the simplex printing is carried out by the image forming section 4A. In this case, the control section 46 stops all operations of the image forming section 4B including the rotation of the photoconductive drum 10B. The intermediate transfer belt driving section 242B is synchronized with the intermediate transfer belt driving section 202A to be operated similar to the duplex printing. However, the pressing to the photoconductive drum 10B of the primary transfer roller 53B is released. Thus, the intermediate transfer belt 56B is in non-contact with the photoconductive drum 10B.

The control section 46 doesn't apply a transfer voltage to the primary transfer roller 53B.

The control section 46 reduces the calorific value of the heater 24e as compared with that at the time of the duplex printing.

As stated above, in the image forming apparatus 102, only the forming process of the toner image Tpc is different, and the transfer operation of the transfer roller 17A and the fixing operation of the fixing device are exactly the same as those in the image forming apparatus 100. Thus, the image forming apparatus 102 has same effects as the image forming apparatus 100 on the transfer operation of the transfer roller 17A and the fixing operation of the fixing device 24.

Further, in accordance with the image forming apparatus 102, as the intermediate transfer belt 56B is arranged, the freedom of arrangement of the photoconductive drum 10B in the image forming apparatus 102 is increased as compared with the image forming apparatus 100.

If adding the image forming sections having different colors like the image forming sections 4A and 4B, it is also possible to carry out multi-color duplex printing.

### A Fourth Embodiment

An image forming apparatus of a fourth embodiment is described.

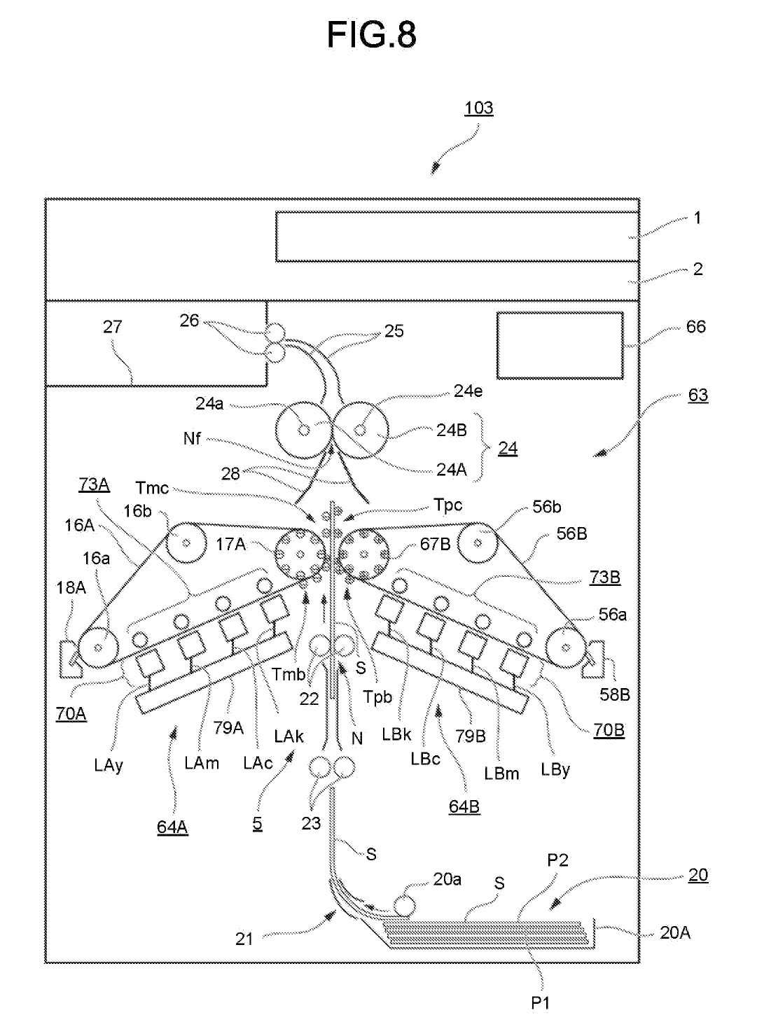

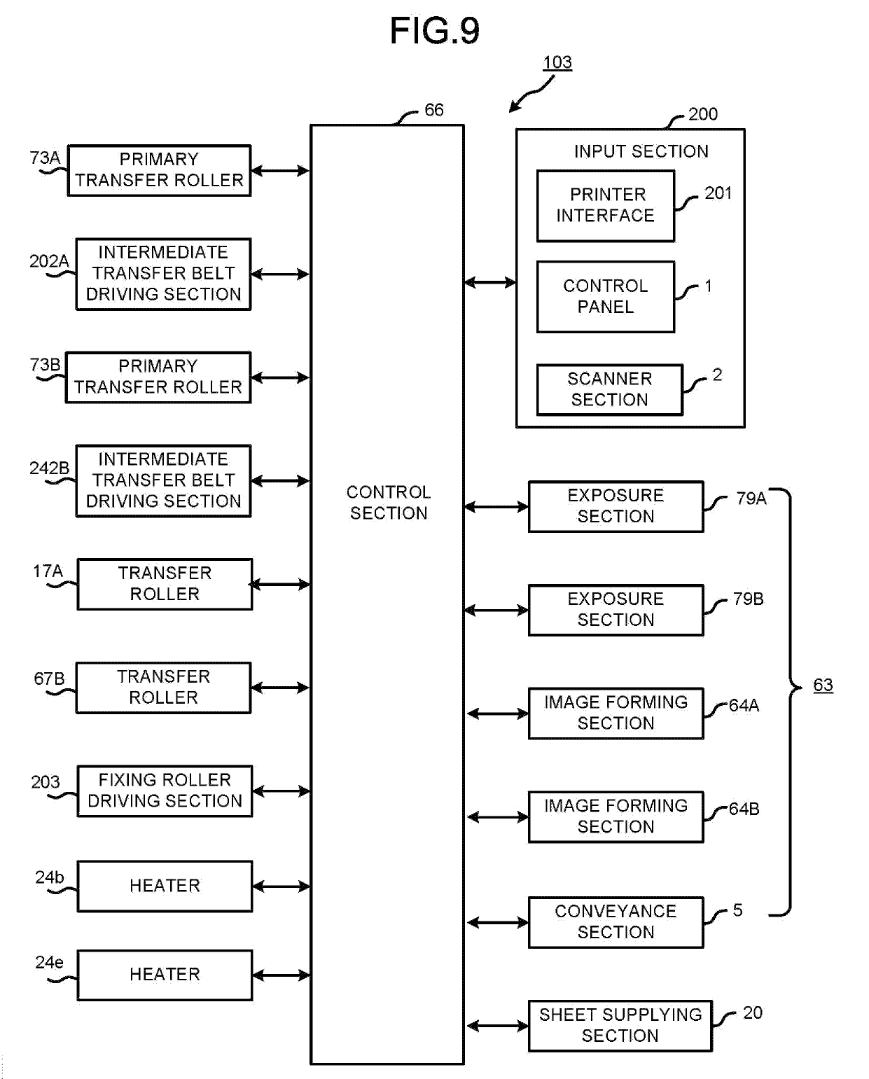

FIG. 8 is a schematic cross-sectional view illustrating an example of the whole constitution of an image forming apparatus according to the fourth embodiment. FIG. 9 is a block diagram illustrating an example of the functional components of the image forming apparatus according to the fourth embodiment.

As shown in FIG. 8, an image forming apparatus 103 of the fourth embodiment is provided with a printer section and a control section 66 instead of the printer section 33 and the control section 46 of the image forming apparatus 102 of the third embodiment described above.

Hereinafter, the point different from the third embodiment described above is mainly described.

Instead of the pressing roller 57B in the printer section 43, the printer section 63 is provided with a transfer roller 67B (second transfer roller). Further, the printer section 63 is provided with an image forming section 64A (first image forming section) and an image forming section 64B (second image forming section) instead of the image forming sections 4A and 4B in the printer section 43. Further, the printer section 63 is provided with primary transfer rollers 73A and 73B instead of the primary transfer rollers 13A and 53B in the printer section 43.

The transfer roller 67B has same constitution as the transfer roller 17A. However, that a positive transfer bias voltage can be applied to the transfer roller 67B by the control section 66 is different from the transfer roller 17A.

The image forming section 64A (64B) forms a toner image of each color with negative (positive) charged yellow, magenta, cyan and black toner. The image forming section 64A can form a full-color image by overlapping the toner image of each color.

The image forming section 64A is provided with four imaging units 70A arranged for each color and an exposure section 79A.

Each of the imaging units 70A has the same constitution comprising the photoconductive drum 10A, the charger 11A, the developing device 12A, the primary transfer roller 13A, the charging device 14A and the cleaning unit 15A.

Similar to the photoconductive drum 10A, the four imaging units 70A face the intermediate transfer belt 16A from the driving roller 16a to the transfer roller 17A.

The four imaging units 70A respectively form a yellow, magenta, cyan and black toner image in the order from the driving roller 16a to the transfer roller 17A.

At positions facing the photoconductive drum in each imaging unit 70A, the primary transfer rollers 73A with same constitution as the primary transfer roller 13A are arranged.

The exposure section 79A irradiates each photoconductive drum of the four imaging units 70A with exposure lights LAy, LAm, LAc and LAk. The exposure lights LAy, LAm, LAc and LAk are modulated according to the yellow, magenta, cyan and black image signals. The exposure section 79A forms an electrostatic latent image based on each image signal on each photoconductive drum of the imaging units 70A.

For example, the exposure section 79A may have a constitution that scans four laser beams. For example, the exposure section 79A may also have a constitution that carries out solid scanning using four LED light-emitting elements.

The image forming section 64B is provided with four imaging units 70B arranged for each color and an exposure section 79B.

Each of the imaging units 70B has the same constitution comprising the photoconductive drum 10B, the charger 11B, the developing device 12B, the primary transfer roller 13B, the charging device 14B and the cleaning unit 15B.

The four imaging units 70B face the intermediate transfer belt 56B from the driving roller 56a to the transfer roller 67B. The four imaging units 70B respectively form a yellow, magenta, cyan and black toner image in the order from the driving roller 16a to the transfer roller 67B.

At positions facing the photoconductive drum in each imaging unit 70B, the primary transfer rollers 73B with same constitution as the primary transfer roller 53B are arranged.

The exposure section 79B irradiates each photoconductive drum of the four imaging units 70B with exposure lights LBy, LBm, LBc and LBk. The exposure lights LBy, LBm, LBc and LBk are modulated according to the yellow, magenta, cyan and black image signals. The exposure section 79B forms an electrostatic latent image based on each image signal on each photoconductive drum.

The exposure section 79B can adopt same constitution as the exposure section 79A.

As shown in FIG. 9, the control section 66 is connected to be capable of communicating with all device parts of the image forming apparatus 103. The control section 66 controls each device part of the image forming apparatus 103. The control section 66 is different from the control section 46 of the third embodiment described above in the controlling of the added imaging units 70A and 70B, the exposure sections 79A and 79B, the primary transfer rollers 73A and 73B and the transfer roller 67B.

The control on the imaging units 70A and 70B, the exposure sections 79A and 79B, and the primary transfer rollers 73A and 73B by the control section 66 is the same as that carried out on the image forming sections 4A and 4B of the third embodiment described above for each color. However, the timing of image formation, developing and primary transfer is different from each other according to the difference of the arrange positions of the four imaging units 70A and 70B. The front end of an image forming range of each color is formed at a timing when all the front ends of the image forming range of each color are moved to the first and the second transfer position at the timing t3.

The control section 66 carries out same control on the transfer roller 67B as the transfer roller 17A excluding applying a positive transfer bias voltage to the transfer roller 67B.

The control section 66 can adopt the same device constitution as that of the control section 46.

As to the operations of the duplex printing of the image forming apparatus 103, the point different from the image forming apparatus 102 of the third embodiment described above is mainly described.

The control section 66 controls the image forming sections 64A and 64B and the primary transfer rollers 73A and 73B to respectively overlap and form toner image of each color on the intermediate transfer belts 16A and 56B. The control section 66 further controls each operation timing such that the front end of the image forming range of each color reach the first and the second transfer positions simultaneously at the timing t3 simultaneously.

The toner image Tmb of each color on the intermediate transfer belt 16A is charged to negative polarity. The toner image Tpb of each color on the intermediate transfer belt 56B is charged to positive polarity.

The control section 66 enables the sheet S to move to the first and the second transfer positions slightly earlier than the timing t3.

Similar to the third embodiment described above, the control section 66 applies a negative transfer bias voltage to the transfer roller 17A. Further, the control section 66 applies a positive transfer bias voltage to the transfer roller 67B simultaneously.

As a result, an electric field from the transfer roller 67B to the transfer roller 17A is generated between the transfer roller 17A and the transfer roller 67B. The toner images Tmb and Tpb that receive an external force from the electric field are respectively transferred to the first surface P1 and the second surface P2 of the sheet S. The toner images Tmc and Tpc are simultaneously formed on the sheet S.

Similar to the third embodiment described above, the sheet S reaches the fixing device 24. The fixing device fixes the toner images Tmc and Tpc on the sheet S simultaneously.

In this way, the image forming apparatus 103 carries out a full-color duplex printing.

The simplex printing can be carried out as the third embodiment if the image formation of the image forming section 64B is stopped.

As stated above, the operation of the image forming apparatus 103 are the same as that of the image forming apparatus 102 excluding the operations of forming the full-color toner image and applying the positive transfer bias voltage to the transfer roller 67B.

Thus, the image forming apparatus 103 has same effects as the image forming apparatus 102 on the fixing operation of the fixing device 24.

Further, the image forming apparatus 103 applies a negative transfer bias voltage to the transfer roller 17A and applies a positive transfer bias voltage to the transfer roller 67B. Thus, the toner image Tpb receives not only an attractive force from the transfer roller 17A but also a repulsive force from the transfer roller 67B. In this way, the toner image Tpb is transferred to the second surface P2 of the sheet S more exactly.

Thus, the efficiency of transfer to the sheet S improves. The image forming apparatus 103 can transfer a better image.

Hereinafter, a modification of the embodiments described above is described.

It is exemplified in the third and the fourth embodiment described above that the image forming apparatuses 102 and 103 convey the sheet S from the lower side to the upper side. However, similar to the second embodiment, the sheet S may also be conveyed from the upper side to the lower side by reversing upside down each device part.

In the fourth embodiment described above, it is exemplified that the image forming apparatus 103 is provided with the transfer roller 67B in a case of carrying out a full-color printing. However, the pressing roller 57B of the image forming apparatus 102 in the third embodiment may be replaced with the transfer roller 67B.

In accordance with at least one embodiment described above, an image forming apparatus comprises a first image forming section, a first intermediate transfer belt, a second image forming section forming a second toner image, and an image carrier. The first image forming section forms a first toner image. The second image forming section forms a second toner image having the opposite polarity to that of the first toner image. The first intermediate transfer belt and a second intermediate transfer belt are opposite to each other at a first secondary transfer position and a second secondary transfer position. The image forming apparatus is further provided with a transfer roller and a fixing device. The transfer roller respectively transfers the toner images to a first surface and a second surface of the sheet simultaneously at the first transfer position and the second transfer position. The fixing device heats and fixes each toner image that are transferred to the first surface and the second surface of the sheet simultaneously. Thus, the image forming apparatus can carry out a duplex printing by only making the sheet pass through the fixing device once. In this way, it is possible for the image forming apparatus to reduce the printing time and the power consumption at the time of fixing.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image forming apparatus, comprising:
a first image forming section configured to form a first toner image using a first toner;
a first intermediate transfer belt formed by an endless belt to which the first toner image is primarily transferred from the first image forming section, configured to move the first toner image that is primarily transferred to a first transfer position where the primarily transferred first toner image is to be secondarily transferred, wherein the first intermediate transfer belt comprises a primary transfer roller that abuts against an inner peripheral surface of the first intermediate transfer belt at a primary transfer position, and wherein a transfer voltage is selectively applied to the primary transfer roller at the primary transfer position;
a second image forming section configured to form a second toner image using a second toner that is charged with opposite polarity to that of the first toner;
an image carrier comprising a photoconductive drum configured to be abutted against the first intermediate transfer belt at the first transfer position, to carry the second toner image and move the second toner image to a second transfer position which faces the first transfer position;
a conveyance section configured to convey a sheet between the first transfer position and the second transfer position;
a transfer roller, which is arranged facing the first transfer position at the inside of the first intermediate transfer belt, configured to transfer the first toner image to a first surface of the sheet and transfer the second toner image to a second surface at the opposite side to the first surface of the sheet by applying a transfer bias voltage; and
a fixing device configured to heat and fix the first toner image and the second toner image that are transferred to the sheet on the sheet simultaneously.

2. The image forming apparatus according to claim 1, wherein
the first toner is charged to negative polarity;
the second toner is charged to positive polarity; and
the transfer bias voltage that is applied to the transfer roller is a negative voltage.

3. The image forming apparatus according to claim 1, wherein
the first transfer position, the second transfer position and a nip of the fixing device are positioned at a same plane along the vertical plane.

4. The image forming apparatus according to claim 3, wherein
the fixing device is positioned below the first transfer position and the second transfer position.

5. (canceled)

6. The image forming apparatus according to claim 1, wherein
the image carrier comprises an endless belt that is a second intermediate transfer belt to which the second toner image is primarily transferred from the second image forming section, and which moves the primarily transferred second toner image to the second transfer position.

7. The image forming apparatus according to claim 1, wherein
at least one of the first image forming section and the second image forming section forms multicolor images.

8. The image forming apparatus according to claim 1, wherein
in a case of forming an image only on single side of the sheet, the first toner image that is formed by the first image forming section is transferred to and fixed on the first surface of the sheet.

9. The image forming apparatus according to claim 1, wherein
the fixing device comprises a first roller provided with a first heater, and a second roller provided with a second heater of which the temperature is controlled independently from the first heater.

10. An image forming method, including:
forming a first toner image using a first toner;
primarily transferring the first toner image to a first intermediate transfer belt, and moving the first toner image that is primarily transferred to a first transfer position of the first intermediate transfer belt, wherein the first intermediate transfer belt comprises a primary transfer roller that abuts against an inner peripheral surface of the first intermediate transfer belt at a primary transfer position, and wherein a transfer voltage is selectively applied to the primary transfer roller at the primary transfer position;
forming a second toner image using a second toner that is charged with opposite polarity to that of the first toner;
moving the second toner image to a second transfer position which faces the first transfer position through an image carrier which abuts against the first intermediate transfer belt at the first transfer position and carries the second toner image, wherein the image carrier is a photoconductive drum;
conveying a sheet between the first transfer position and the second transfer position;
transferring the first toner image to a first surface of the sheet and transferring the second toner image to a second surface at the opposite side to the first surface of the sheet by applying a transfer bias voltage having a charged polarity to a transfer roller which is arranged facing the first transfer position at the inside of the first intermediate transfer belt; and
heating and fixing the first toner image and the second toner image that are transferred to the sheet on the sheet simultaneously.
